(19) United States
(12) Patent Application Publication
(10) Pub. No.: US 2024/0334461 A1
(43) Pub. Date: Oct. 3, 2024

(54) Signalling in a Split Radio Network Node Architecture

(71) Applicant: Telefonaktiebolaget LM Ericsson (publ), Stockholm (SE)

(72) Inventors: Yazid Lyazidi, London (GB); Liwei Qiu, Täby (SE); Mattias Bergström, Sollentuna (SE); Andreas Höglund, Solna (SE); Tuomas Tirronen, Helsinki (FI)

(21) Appl. No.: 18/578,528

(22) PCT Filed: Jul. 12, 2022
(86) PCT No.: PCT/EP2022/069473

§ 371 Date: Jan. 11, 2024

Related U.S. Application Data
(60) Provisional application No. 63/220,856, filed on Jul. 12, 2021.

(51) Int. Cl. H04W 72/51; H04W 68/02

(52) U.S. Cl. CPC H04W 72/51; H04W 68/02

(57) ABSTRACT

A radio network node (14) is split into a centralized unit (14A) and one or more distributed units in a radio access network (10). A distributed unit (14B) of the radio network node (14) transmits, to the centralized unit (14A), information (20) indicating that a wireless communication device (12) is a Reduced Capability, RedCap, User Equipment, UE. The information (20) may be transmitted, for example, in a RedCap Indication information element of a message transmitted to the centralized unit (14A), e.g., in INITIAL UL RRC MESSAGE TRANSFER message.

### TECHNICAL FIELD

The present application relates generally to a split radio network node architecture and relates more particularly to signaling in such an architecture.

### BACKGROUND

The initial release of 5G in Release 15 is optimized for mobile broadband (MBB) and ultra-reliable and low latency communication (URLLC). These services require very high data rates and/or low latency and therefore put high requirements on the user equipment (UE). To enable 5G to be used for other services with more relaxed performance requirements, a new low complexity UE-type is introduced in Release 17, called ‘reduced capability NR devices’ or RedCap. The low complexity UE-type is particularly suited for machine type communication (MTC) services such as wireless sensors or video surveillance, but it can also be used for MBB services with lower performance requirements such as wearables. The low complexity UE in Rel-17 has reduced capabilities compared to a Release 15 New Radio (NR) UE. See, e.g., the Rel-17 work item description in RP-210918. Because of the reduced capabilities, the low complexity UE is sometimes also referred to as an NR RedCap UE.

A RedCap UE may for example be defined by the support of a maximum UE bandwidth of 20 MHZ (in FR1) or 100 MHz (in FR2), possible support of only one multiple-input multiple-output (MIMO) layer and/or only one Rx antenna branch, support for 64 QAM in the downlink (with 256 QAM being optional), and half-duplex frequency division duplexing (HD-FDD) operation within one carrier.

Although RedCap UEs enable 5G to be used for other services with more relaxed performance requirements, RedCap UEs introduce challenges in a split radio network architecture. A split radio network architecture splits radio network equipment (e.g., a base station) into a so-called centralized unit (CU) and one or more so-called distributed units (DUs). The central unit terminates higher layer and/or less time-critical protocols, such as the Packet Data Convergence Protocol (PDCP) and Radio Resource Control (RRC) protocols towards a wireless device. The centralized unit also controls the operations of the distributed unit(s). A distributed unit by contrast terminates lower layer and/or more time-critical protocols, such as the Radio Link Control (RLC), Medium Access Control (MAC), and physical layer protocols. The split nature of the radio network equipment threatens to insulate the CU and/or DU(s) from the RedCap nature of a UE in such a way that RedCap UEs would negatively impact the network.

### SUMMARY

Some embodiments herein account for Reduced Capability (RedCap) User Equipment (UE) in a radio access network with a split architecture. Some embodiments in this regard provide support for RedCap UE indications in procedure(s) between a centralized unit (CU) and a distributed unit (DU) of radio network equipment, e.g., in procedures for initial UE access, UE context setup, and/or paging. Support for RedCap UE indications in these and other embodiments may advantageously enable procedures in a split radio network architecture to account for the RedCap nature of UEs, e.g., as needed to optimize the network and/or otherwise tailor the procedures for RedCap UEs.

More particularly, embodiments herein include a method performed by a distributed unit of a radio network node that is split into a centralized unit and one or more distributed units in a radio access network. The method comprises transmitting, from the distributed unit to the centralized unit, information indicating that a wireless communication device is a Reduced Capability, RedCap, User Equipment, UE.

In some embodiments, the information is transmitted over an F1 interface between the distributed unit and the centralized unit.

In some embodiments, the information is transmitted in a message sent by the distributed unit to transfer an initial layer 3 message to the centralized unit.

In some embodiments, the information is transmitted in an INITIAL UL RRC MESSAGE TRANSFER message.

In some embodiments, a RedCap UE has a maximum bandwidth of 20 MHz in a first frequency range, FR1, and a maximum bandwidth of 100 MHz in a second frequency range, FR2. In some embodiments, a RedCap UE lacks support for carrier aggregation and lacks support for dual connectivity. In some embodiments, a RedCap UE supports a maximum of 2 receive branches and/or a maximum of 2 downlink multiple-input multiple-output layers.

In some embodiments, the information indicates that the wireless communication device is a New Radio, NR, RedCap UE

In some embodiments, the information is included in a RedCap Indication information element of a message transmitted from the distributed unit to the centralized unit.

In some embodiments, the method further comprises receiving, from the wireless communication device, in a random access procedure, an indication that the wireless communication device is a RedCap UE. In some embodiments, the information is transmitted to the central unit in response to receiving the indication from the wireless communication device.

In some embodiments, the method further comprises receiving, from the centralized unit, a paging message that requests the distributed unit to page a wireless communication device. In some embodiments, the paging message includes information indicating that the wireless communication device to be paged is a RedCap UE. In this case, the method further comprises paging the wireless communication device based on the information included in the paging message.

Other embodiments herein include a method performed by a central unit of a radio network node that is split into the centralized unit and one or more distributed units in a radio access network. The method comprises receiving, from a distributed unit of the radio network node, information that a wireless communication device is a Reduced Capability, RedCap, User Equipment, UE.

In some embodiments, the information is received over an F1 interface between the distributed unit and the centralized unit.

In some embodiments, the information is received in a message sent by the distributed unit to transfer an initial layer 3 message to the centralized unit.

In some embodiments, the information is received in an INITIAL UL RRC MESSAGE TRANSFER message.

In some embodiments, the information indicates that the wireless communication device is a New Radio, NR, RedCap UE.

In some embodiments, a RedCap UE has a maximum bandwidth of 20 MHz in a first frequency range, FR1, and a maximum bandwidth of 100 MHz in a second frequency range, FR2. In some embodiments, a RedCap UE lacks support for carrier aggregation and lacks support for dual connectivity. In some embodiments, a RedCap UE supports a maximum of 2 receive branches and/or a maximum of 2 downlink multiple-input multiple-output layers.

In some embodiments, the information is included in a RedCap Indication information element of a message received from the distributed unit.

In some embodiments, the method further comprises, responsive to receiving the information, transmitting, to another network node, an indication that the wireless communication device is a RedCap UE. In some embodiments, the indication is transmitted in an INITIAL UE MESSAGE. Additionally or alternatively in other embodiments, the another network node implements an Access and Mobility Function, AMF.

In some embodiments, the method further comprises transmitting, to the distributed unit, a paging message that requests the distributed unit to page a wireless communication device. In some embodiments, the paging message includes information indicating that the wireless communication device to be paged is a RedCap UE.

Other embodiments herein include a distributed unit of a radio network node that is split into a centralized unit and one or more distributed units in a radio access network. The distributed unit is configured to transmit, from the distributed unit to the centralized unit, information indicating that a wireless communication device is a Reduced Capability, RedCap, User Equipment, UE.

In some embodiments, the distributed unit is configured to perform the steps described above for a distributed unit.

Other embodiments herein include a central unit of a radio network node that is split into the centralized unit and one or more distributed units in a radio access network. The central unit is configured to receive, from a distributed unit of the radio network node, information that a wireless communication device is a Reduced Capability, RedCap, User Equipment, UE.

In some embodiments, the central unit is configured to perform the steps described above for a central unit.

Other embodiments herein include a computer program comprising instructions which, when executed by at least one processor of a distributed unit of a radio network node that is split into a centralized unit and one or more distributed units in a radio access network, causes the distributed unit to perform the steps described above for a distributed unit. Other embodiments herein include a computer program comprising instructions which, when executed by at least one processor of a central unit of a radio network node that is split into the centralized unit and one or more distributed units in a radio access network, causes the central unit to perform the steps described above for a central unit. In some embodiments, a carrier containing the computer program is one of an electronic signal, optical signal, radio signal, or computer readable storage medium.

Other embodiments herein include a distributed unit of a radio network node that is split into a centralized unit and one or more distributed units in a radio access network. The distributed unit comprises communication circuitry and processing circuitry. The processing circuitry is configured to transmit, from the distributed unit to the centralized unit, information indicating that a wireless communication device is a Reduced Capability, RedCap, User Equipment, UE.

In some embodiments, the processing circuitry is configured to perform the steps described above for a distributed unit.

Other embodiments herein include a central unit of a radio network node that is split into the centralized unit and one or more distributed units in a radio access network. The central unit comprises communication circuitry and processing circuitry. The processing circuitry is configured to receive, from a distributed unit of the radio network node, information that a wireless communication device is a Reduced Capability, RedCap, User Equipment, UE.

In some embodiments, the processing circuitry is configured to perform the steps described above for a central unit.

Although some embodiments herein are exemplified as relating to RedCap UEs, embodiments herein may be extended generally to any type of, capability of, configuration of, and/or feature supported by a wireless communication device. A wireless communication device being a RedCap UE is thereby just one example of a type of, capability of, configuration of, and/or feature supported by a wireless communication device herein.

### BRIEF DESCRIPTION OF THE DRAWINGS

FIG. 1 is a block diagram of a radio access network according to some embodiments.

FIG. 2 is a logic flow diagram of a method performed by a distributed unit of a radio network node according to some embodiments.

FIG. 3 is a logic flow diagram of a method performed by a centralized unit of a radio network node according to some embodiments.

FIG. 4 is a block diagram of a split radio access network architecture in an LTE network and an NR network according to some embodiments.

FIG. 5 is a call flow diagram of a UE Initial Access procedure according to some embodiments.

FIG. 6 is a call flow diagram of an inter-gNB-DU mobility procedure for intra-NR according to some embodiments.

FIG. 7 is a call flow diagram of an F1 Paging procedure according to some embodiments.

FIG. 8 is a block diagram of a distributed unit of a radio network node according to some embodiments.

FIG. 9 is a block diagram of a centralized unit of a radio network node according to some embodiments.

FIG. 10 is a block diagram of a network node according to some embodiments.

FIG. 11 is a block diagram of a communication system in accordance with some embodiments

FIG. 12 is a block diagram of a user equipment according to some embodiments.

FIG. 13 is a block diagram of a network node according to some embodiments.

FIG. 14 is a block diagram of a host according to some embodiments.

FIG. 15 is a block diagram of a virtualization environment according to some embodiments.

FIG. 16 is a block diagram of a host communicating via a network node with a UE over a partially wireless connection in accordance with some embodiments.

### DETAILED DESCRIPTION

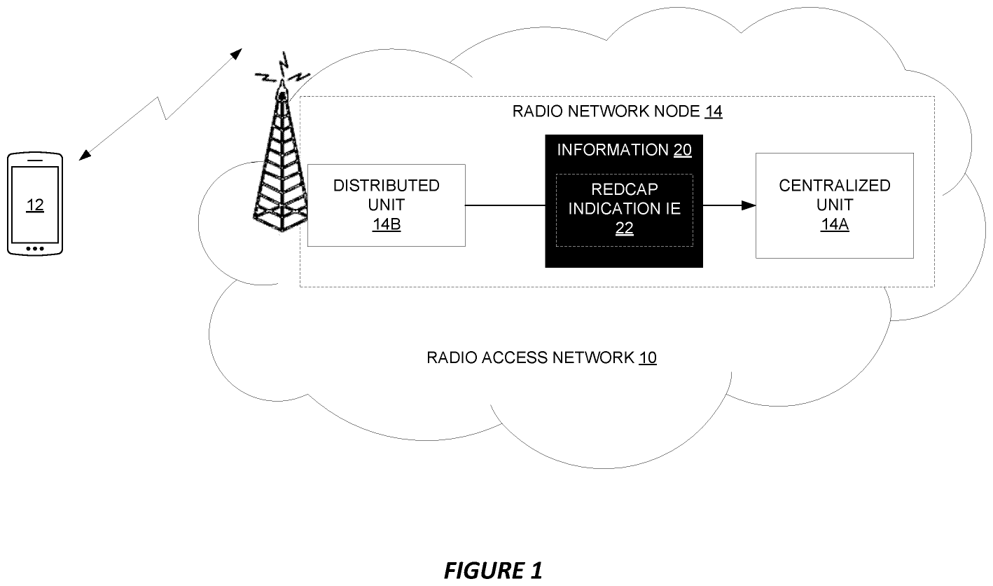

FIG. 1 shows a radio access network (RAN) 10 that provides radio access to a wireless communication device 12 according to some embodiments. The RAN 10 may for example be a 5G RAN. The RAN 10 includes a radio network node 14 that is split into a centralized unit 14A and one or more distributed units (DUs), one of which is shown as distributed unit 14B.

In some embodiments, the centralized unit 14A terminates higher layer and/or less time-critical protocols, such as the Packet Data Convergence Protocol (PDCP) and Radio Resource Control (RRC) protocols towards the wireless communication device 12. The centralized unit 14A also controls the operations of the distributed unit(s). A distributed unit by contrast terminates lower layer and/or more time-critical protocols, such as the Radio Link Control (RLC), Medium Access Control (MAC), and physical layer protocols.

As shown in FIG. 1, the distributed unit 14B in some embodiments transmits information 20 to the centralized unit 14A, e.g., over an F1 interface between the distributed unit 14B and the centralized unit 14A. The information 20 indicates a type of, capability of, configuration of, and/or feature supported by the wireless communication device 12.

In some embodiments, the distributed unit 14B transmits this information 20 to the centralized unit 14A responsive to, or based on, receiving an indication from the wireless communication device 12 itself indicating the type of, capability of, configuration of, and/or feature supported by the wireless communication device 12. The distributed unit 14B may for example receive such an indication in a random access procedure with the wireless communication device and then transmit the information 20 to the centralized unit 14A in response to receiving such an indication.

Regardless, equipped with the information 20, the centralized unit 14A may thereafter account for the type of, capability of, configuration of, and/or feature supported by the wireless communication device 12. The centralized unit 14A may for example take such into account when paging the wireless communication device 12. In one embodiment, for instance, the centralized unit 14A transmits, to the distributed unit 14B, a paging message (not shown) that requests the distributed unit 14B to page the wireless communication device 12, where the paging message includes information indicating that the wireless communication device 12 to be paged has a certain type, capability, and/or configuration and/or supports a certain feature. The distributed unit 14B may then control its paging based on the information included in the paging message.

In one example, the information 20 that the distributed unit 14B transmits to the centralized unit 14A indicates that the wireless communication device 12 is a Reduced Capability (RedCap) User Equipment (UE), e.g., a New Radio (NR) RedCap UE. The information 20 may for example be included in a RedCap Indication information element (IE) 22 of a message transmitted from the distributed unit 14B to the centralized unit 14A, e.g., a message sent by the distributed unit 14B to transfer an initial layer 3 message to the centralized unit 14A, such as an INITIAL UL RRC MESSAGE TRANSFER message. In these embodiments, then, the centralized unit 14A may account for the RedCap nature of the wireless communication device 12, e.g., when paging the wireless communication device 12.

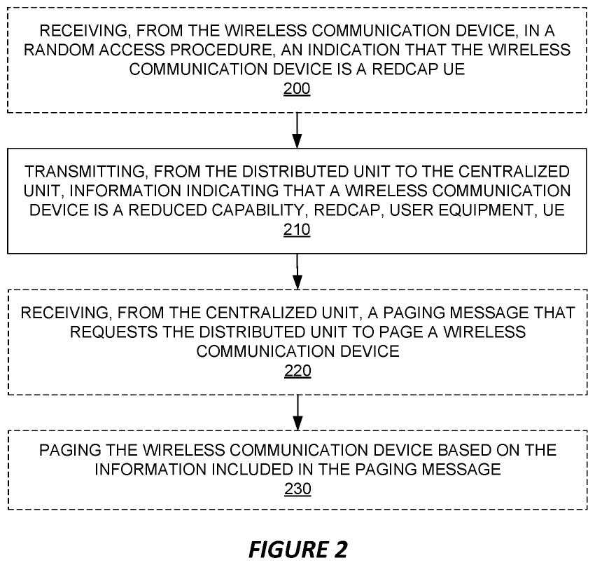

FIG. 2 depicts a method in accordance with one or more of these embodiments related to RedCap UEs. The method is performed by a distributed unit (DU) 14B of a radio network node 14 that is split into a centralized unit (CU) 14A and one or more distributed units (DUs) in a radio access network 10. The method includes transmitting, from the distributed unit 14B to the centralized unit 14A, information 20 indicating that a wireless communication device 12 is a Reduced Capability, RedCap, User Equipment, UE (Block 210).

In some embodiments, the method also includes receiving, from the wireless communication device 12, in a random access procedure, an indication that the wireless communication device 12 is a RedCap UE (Block 200). In one such embodiment, then, the step of transmitting the information 20 to the centralized unit 14A may be performed response to, or based on, the indication received from the wireless communication device 12.

In any event, in some embodiments, the method also includes receiving, from the centralized unit 14A, a paging message that requests the distributed unit 14B to page a wireless communication device 12 (Block 220). In one embodiment, the paging message includes information indicating that the wireless communication device 12 to be paged is a RedCap UE. The method in this case may also include paging the wireless communication device 12 based on the information included in the paging message (Block 230).

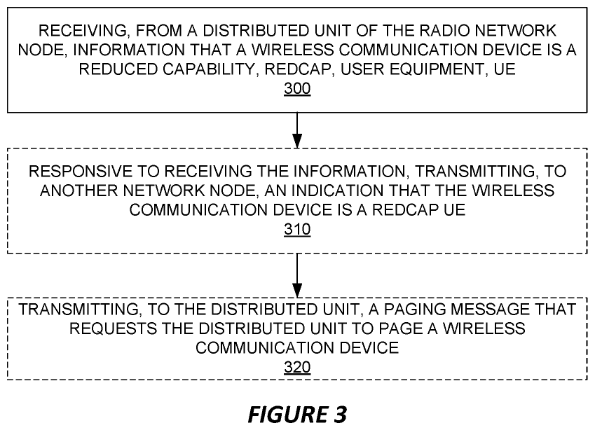

FIG. 3 depicts a method in accordance with other particular embodiments related to RedCap UEs. The method is performed by a central unit 14A of a radio network node 14 that is split into the centralized unit 14A and one or more distributed units in a radio access network 10. The method includes receiving, from a distributed unit 14B of the radio network node 14, information 20 that a wireless communication device 12 is a Reduced Capability, RedCap, User Equipment, UE (Block 300).

In some embodiments, the method also includes, responsive to receiving the information 20, transmitting, to another network node, an indication that the wireless communication device 12 is a RedCap UE (Block 310).

Alternatively or additionally, in some embodiments, the method also includes transmitting, to the distributed unit 14B, a paging message that requests the distributed unit 14B to page a wireless communication device 12 (Block 320). In one embodiment, the paging message includes information indicating that the wireless communication device 12 to be paged is a RedCap UE.

In some embodiments herein, a RedCap UE may be as described below. A RedCap UE may for instance have a reduced maximum UE bandwidth. For example, the maximum bandwidth of a frequency range 1 (FR1) RedCap UE during and after initial access may be 20 MHz and/or the maximum bandwidth of a frequency range 2 (FR2) RedCap UE during and after initial access may be 100 MHz. Alternatively or additionally, a RedCap UE may have a reduced minimum number of receive (Rx) branches. For example, for frequency bands where a legacy NR UE is required to be equipped with a minimum of 2 Rx antenna ports, the minimum number of Rx branches supported by specification for a RedCap UE may be 1. The specification may also support 2 Rx branches for a RedCap UE in these bands. Or, for frequency bands where a legacy NR UE (other than 2-Rx vehicular UE) is required to be equipped with a minimum of 4 Rx antenna ports, the minimum number of Rx branches supported by specification for a RedCap UE may be 1. The specification in this case also supports 2 Rx branches for a RedCap UE in these bands. Alternatively or additionally, a RedCap UE may have a reduced maximum number of downlink (DL) multiple-input multiple-output (MIMO) layers. For example, for a RedCap UE with 1 Rx branch, 1 DL MIMO layer is supported. Or, for a RedCap UE with 2 Rx branches, 2 DL MIMO layers are supported. Alternatively or additionally, a RedCap UE may have a relaxed maximum modulation order. For example, for an FR1 RedCap UE, support of 256 QAM in the downlink (DL) is optional (instead of mandatory). In one embodiment, no other relaxations of maximum modulation order are specified for a RedCap UE. Alternatively or additionally, a RedCap UE may support half-duplex frequency division duplexing (FDD) type A with minimum specification impact. (Note that FD-FDD and TDD are also supported.)

In some embodiments, a RedCap UE type may be defined to include capabilities for RedCap UE identification and for constraining the use of those RedCap capabilities only for RedCap UEs, and preventing RedCap UEs from using capabilities not intended for RedCap UEs including at least carrier aggregation, dual connectivity and wider bandwidths. In some embodiments, functionality is specified to enable RedCap UEs to be explicitly identifiable to the network through an early indication in a random access procedure, e.g., in Msg1 and/or Msg3, and Msg A if supported, including the ability for the early indication to be configurable by the network.

In some embodiments, a system information indication may be specified to indicate whether a RedCap UE can camp on a cell/frequency or not. In one embodiment, it is possible for the indication to be specific to the number of Rx branches of the UE. For example, System Information Block #1 (SIB1), not the Master Information Block (MIB), may indicate cell barring for 1 Rx branch and 2 Rx branches separately for RedCap UEs. The cell barring for RedCap UE is per cell (not per Public Land Mobile Network, PLMN). In one embodiment, RedCap UE support the Intra Frequency Reselection Indicator. Either Msg1 and/or Msg3 early identification may be supported.

In some embodiments herein, the split radio network architecture may be consistent with that specified by 3GPP for a 5G network, where the radio network node 14 in FIG. 1 is exemplified as a split gNB. In this case, an interface called F1 exists inside the gNB that is interconnecting a gNB-Central Unit (gNB-CU) with one or many gNB-Distributed Units (gNB-DU).

As an example of the centralized unit 14A, the gNB Central Unit (gNB-CU) is a logical node hosting RRC, Service Data Adaption Protocol (SDAP), and PDCP protocols of the gNB or RRC and PDCP protocols of the en-gNB that controls the operation of one or more gNB-DUs. The gNB-CU terminates the F1 interface connected with the gNB-DU.

As an example of the distributed unit 14B, the gNB Distributed Unit (gNB-DU) is a logical node hosting RLC, MAC, and PHY layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.

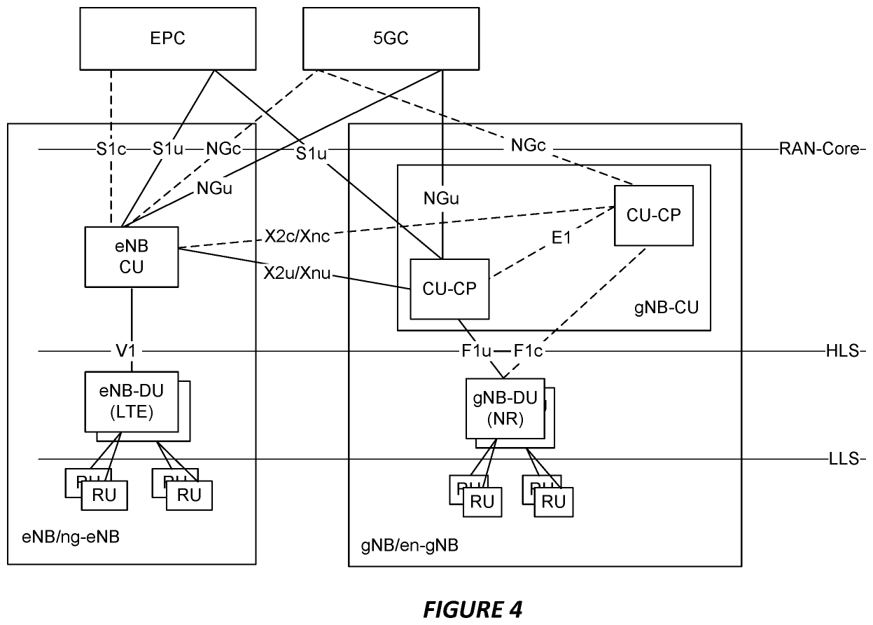

FIG. 4 illustrates the difference between the two NG-RAN architectures for Long Term Evolution (LTE) and NR.

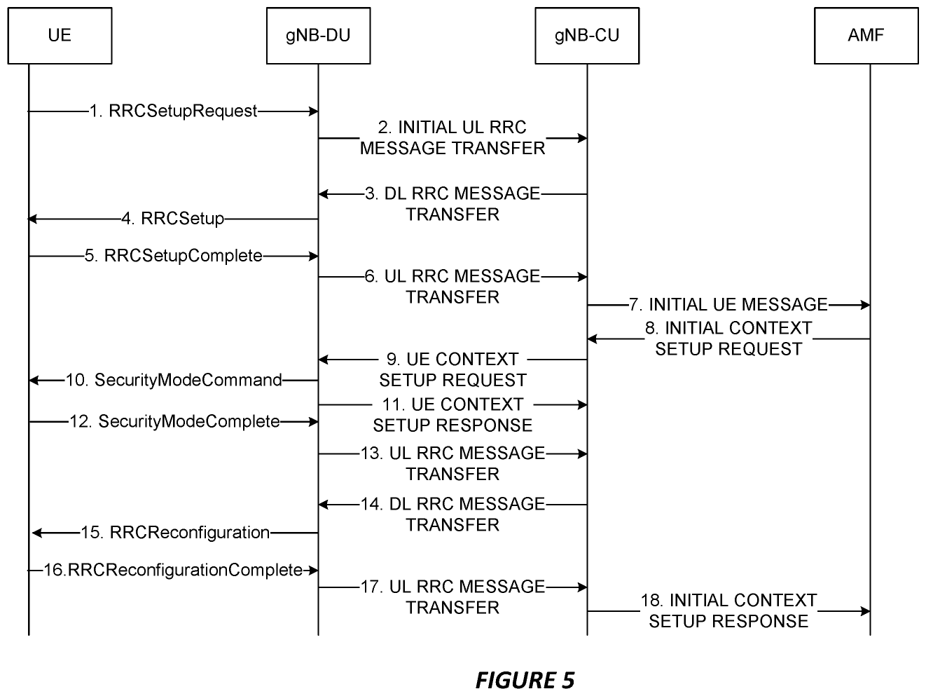

In these and other contexts, the distributed unit 14B in some embodiments herein transmits the information 20 to the centralized unit 14A in a UE Initial Access procedure as shown in FIG. 5. As shown in FIG. 5 in this regard, the gNB-DU in some embodiments transmits the information 20 herein in the INITIAL UL RRC MESSAGE TRANSFER message in Step 2 of FIG. 5. Alternatively or additionally, when receiving the RRC CONNECTION SETUP COMPLETE message indication that the UE is of RedCap type, the gNB-CU adds a RedCap indication in the INITIAL UE MESSAGE to the AMF, eventually with number of Rx branches (step 7). The other steps of the procedure may follow from their description in 3GPP TS 38.401 v16.6.0.

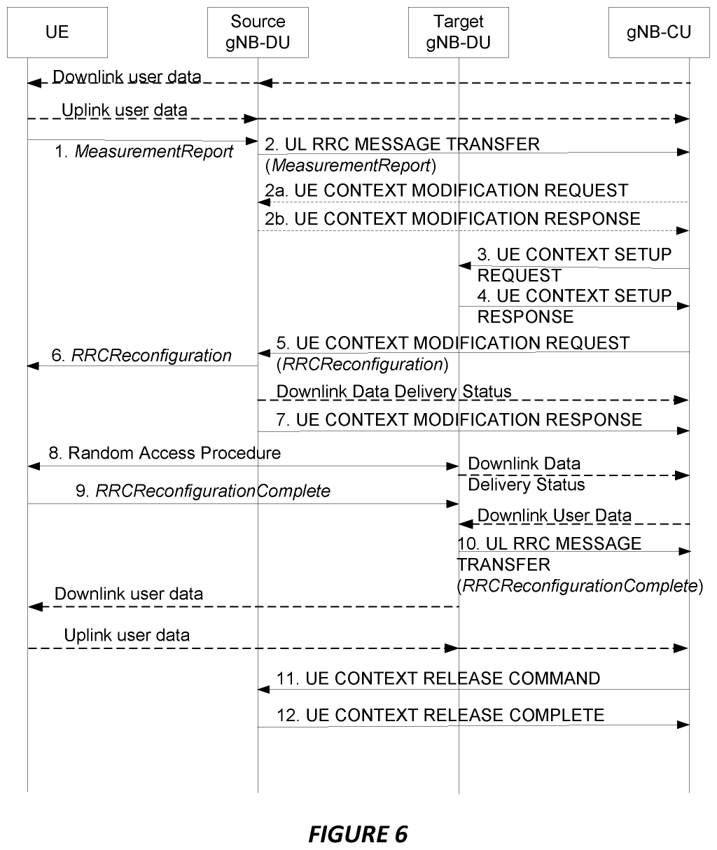

Alternatively or additionally, some embodiments herein take into account the RedCap nature of a UE in the inter-gNB-DU mobility procedures for intra-NR shown in FIG. 6. The procedure is used for the case when the UE moves from one gNB-DU to another gNB-DU within the same gNB-CU during NR operation.

In particular, for intra-gNB-DU Mobility, this procedure is used for the case that the UE moves from one cell to another cell within the same gNB-DU or for the case that intra-cell handover is performed during NR operation, and supported by the UE Context Modification (gNB-CU initiated) procedure as specified in TS 38.473 v16.6.0. When the intra-gNB-DU handover is performed (either inter-cell or intra-cell), the gNB-CU provides a new UL General Packet Radio Service (GPRS) Tunnelling Protocol (GTP) Tunnel Endpoint ID (TEID) to the gNB-DU and the gNB-DU provides new DL GTP TEID to the gNB-CU.

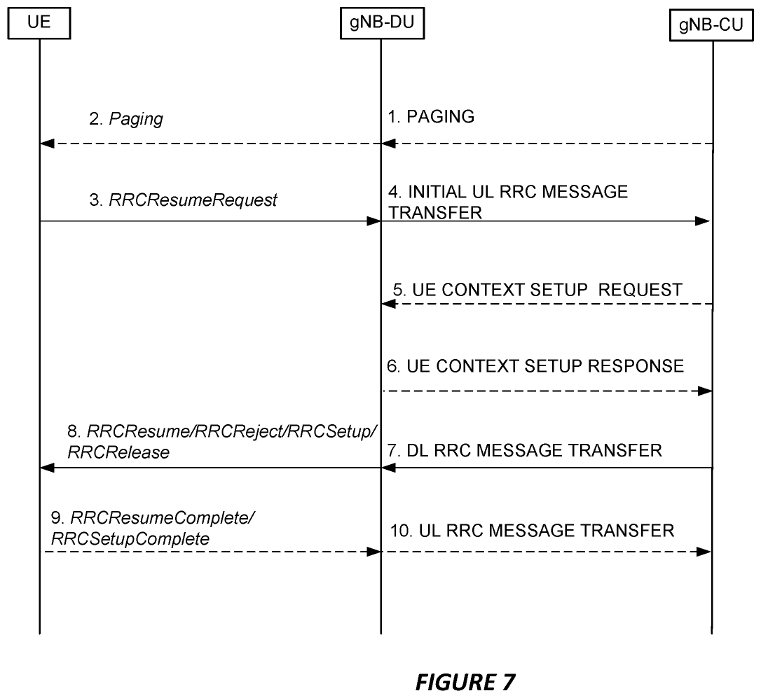

Alternatively or additionally, some embodiments herein account for the RedCap nature of a UE for F1 Paging shown in FIG. 7. This procedure is triggered when receiving a core network (CN) Paging message for subsequent DL data.

Generally, in this context, some embodiments herein support RedCap UEs related signalling in a split gNB architecture. Some embodiments in this regard define some extensions in F1AP specification, e.g., to enable RedCap UE barring/cell restrictions when possible. That is, a gNB-CU according to some embodiments is able to configure/control which gNB-DUs should serve RedCap UEs in which cells, so that the impacts of RedCap UEs on the network are minimized.

Some embodiments herein also consider mobility aspects for intra/inter gNB-DU mobility when a RedCap access restriction is in place. A gNB-CU according to some embodiments, for example, is able to configure the list of DUs/cells where a RedCap UE can handover to or not.

Furthermore, to support Msg1/Msg3 based on-demand system information, the gNB-DU is responsible for the encoding of SIB1. Some embodiments enable the SIB1 broadcasting to consider the cell barring aspect.

Some embodiments accordingly provide methods to support RedCap UE identification over F1AP procedures which may be used for specific reasons, e.g., initial UE access, UE context setup and paging process, resource coordination and gNB-DU mobility restrictions.

For example, from gNB-DU perspective, when receiving an early indication that the UE is of RedCap type (e.g., in Msg3) the node adds a RedCap UE indication in the F1 INITIAL UL RRC MESSAGE TRANSFER message to the gNB-CU with number of Rx branches. (step 2 from FIG. 5).

As another example, from gNB-CU perspective, when receiving the RRC CONNECTION SETUP COMPLETE message indication that the UE is of RedCap type, the gNB-CU adds a RedCap indication in the INITIAL UE MESSAGE to the AMF, eventually with number of Rx branches. (step 7 from FIG. 5).

Alternatively or additionally, during the set-up of the UE context in RAN, the gNB-CU can decide which gNB-DUs or which cells in a specific gNB-DU should be serving and restricting RedCap UEs' access. There can be many motivations for this, for instance for the purpose of load balancing between cells serving UEs of different types and deciding to aggregate all RedCap UEs types in e.g., one gNB-DU to alleviate their potential interference to non-redcap UEs. Another reason would be to set up DUs serving different radio access technology (RAT) types and separate the dedicated traffic coming from those cells, etc.

Alternatively or additionally, when setting up which DUs can be serving RedCap UEs, the gNB-CU sends the UE Radio Capability and possible extended Discontinuous Reception (eDRX) information (such as eDRX cycles and Paging Time Window (PTW)) to those specific gNB-DUs. For example, when setting up cells in different DUs handling RedCap UEs and non-RedCap UEs, the gNB-CU sends to the gNB-DUs a list of cells which should be serving RedCap UEs, or alternatively, a list of cells for which the access is restricted to RedCap UEs (e.g., step 9 of FIG. 5). Alternatively, the gNB-CU can send a RedCap indication as a new RAT type over F1 signalling. Regardless, this can be done via new signalling or using the existing UE CONTEXT SETUP REQUEST procedure (example during step 8 of FIG. 5).

Alternatively or additionally, during Inter-gNB-DU Mobility, when the RedCap UE performs mobility to another DU allowed to serve RedCap UE, the gNB-CU can send assistance information to this gNB-DU, which can be a new indicator or new RRC container, in order to perform load and resource management between its DUs. This can be done via new signalling or using the existing UE CONTEXT MODIFICATION REQUEST procedure.

Alternatively or additionally, during an F1 paging process, the gNB-CU provides RedCap UE paging capabilities information to enable the gNB-DU to calculate the exact Paging occasion (PO) and Paging Frame (PF) for the RedCap UE. The gNB-CU also provides Paging eDRX information to the gNB-DU.

Generally, then, some embodiments herein may advantageously provide support of RedCap UE indications in a split gNB-architecture for one or more functions above.

Consider now some specific examples for RedCap UEs. Consider first an example for initial UE access. In one embodiment, the gNB-DU adds a RedCap UE indication with its lower layer configuration in the INITIAL UL RRC MESSAGE TRANSFER to the gNB-CU. This RedCap UE indication is one example of the RedCap UE indication IE 22 in FIG. 1. In some embodiments, the number of Rx branches can also be indicated.

Table 1 below indicates the contents of an INITIAL UL RRC MESSAGE TRANSFER according to one or more such embodiments. This message is sent by the gNB-DU to transfer the initial layer 3 message to the gNB-CU over the F1 interface. As shown, the RedCap Identification IE may have values Rx1, Rx2, etc, where Rx1 means the RedCap UE supports 1 Rx branch, Rx2 means the RedCap UE supports 2 Rx branches, etc.

TABLE 1

| | | IE type and | | | Assigned |
|---|---|---|---|---|---|
| IE/Group Name | Presence | reference | Semantics description | Criticality | Criticality |
| Message Type | M | 9.3.1.1 | | YES | ignore |
| gNB-DU UE F1AP | M | 9.3.1.5 | | YES | reject |
| ID | | | | | |
| NR CGI | M | 9.3.1.12 | NG-RAN Cell Global | YES | reject |
| | | | Identifier (NR CGI) | | |
| C-RNTI | M | 9.3.1.32 | C-RNTI allocated at the | YES | reject |
| | | | gNB-DU | | |
| RRC-Container | M | 9.3.1.6 | Includes the UL-CCCH- | YES | reject |
| | | | Message IE or UL- | | |
| | | | CCCH1-Message IE as | | |
| | | | defined in subclause 6.2 of | | |
| | | | TS 38.331. | | |
| DU to CU RRC | O | OCTET | CellGroupConfig IE as | YES | reject |
| Container | | STRING | defined in subclause 6.3.2 | | |
| | | | in TS 38.331. Required at | | |
| | | | least to carry SRB1 | | |
| | | | configuration. The | | |
| | | | ReconfigurationWithSync | | |
| | | | field is not included in the | | |
| | | | CellGroupConfig IE. | | |
| SUL Access | O | ENUMERATED | | YES | ignore |
| Indication | | (true, . . . ) | | | |
| Transaction ID | M | 9.3.1.23 | | YES | Ignore |
| RAN UE ID | O | OCTET | | YES | ignore |
| | | STRING | | | |
| | | (SIZE (8)) | | | |
| RRC-Container- | O | 9.3.1.6 | Includes the UL-DCCH- | YES | ignore |
| RRCSetupComplete | | | Message IE including the | | |
| | | | RRCSetupComplete | | |
| | | | message, as defined in | | |
| | | | subclause 6.2 of TS | | |
| | | | 38.331. | | |
| RedCap | O | Enumerated | ‘Rx1’ means the RedCap | YES | ignore |
| Identification | | (Rx1, | UE supports 1 Rx branch, | | |
| | | Rx2 . . . ) | ‘Rx2’ means the RedCap | | |
| | | | UE supports 2 Rx | | |
| | | | branches. | | |

Consider next an example for UE context management.

In one embodiment, the gNB-CU decides which gNB-DUs and which cells among each gNB-DU should bar or allow serving RedCap UEs.

In another embodiment, the gNB-CU sends information on RedCap UE to the gNB-DU, or target gNB-DU in case of intra-gNB-DU mobility, during the UE CONTEXT SETUP REQUEST. This may include a list of cells in which the gNB-DU should restrict RedCap UEs access, e.g., the gNB-DU may use this information when broadcasting SIB1. Alternatively or additionally, the gNB-CU sends a list of cells where gNB-DU should allow RedCap UEs access. In this case, the gNB-CU may send an indication on RedCap UE identification as above, Redcap UE NR Radio capabilities, RedCap UE capability information needed for paging, Paging eDRX parameters (such as eDRX cycle length, and paging transmission window (PTW) length for RAN-triggered paging), and/or other assistance info for RedCap UE Inactive paging, e.g., RedCap UE specific DRX.

In one such embodiment, the gNB-CU sends a UE CONTEXT SETUP REQUEST message as shown in Table 2. This message is sent by the gNB-CU to request the setup of a UE context.

TABLE 2

| | | IE type and | | | Assigned |
|---|---|---|---|---|---|
| IE/Group Name | Presence | reference | Semantics description | Criticality | Criticality |
| Message Type | M | 9.3.1.1 | | YES | reject |
| gNB-CU UE | M | 9.3.1.4 | | YES | reject |
| F1AP ID | | | | | |
| gNB-DU UE | O | 9.3.1.5 | | YES | ignore |
| F1AP ID | | | | | |
| List of | | | List of restricted cells for | | |
| restricted cells | | | redcap UEs | | |
| NR CGI | | | | | |
| List of allowed | | | List of restricted cells for | | |
| cells | | | redcap UEs | | |
| NR CGI | | | | | |
| RedCap | O | Enumerated | ‘Rx1’ means the RedCap | YES | ignore |
| Identification | | (Rx1, | UE supports 1 Rx branch, | | |
| | | Rx2, . . . ) | ‘Rx2’ means the RedCap | | |
| | | | UE supports 2 Rx | | |
| | | | branches. | | |
| UE Radio | O | OCTET | Includes the RRC | YES | ignore |
| Capability | | STRING | UERadioAccessCapability | | |
| | | | Information message as | | |
| | | | defined in TS 38.331 [xx] | | |
| UE Radio | O | OCTET | Includes the RRC | YES | ignore |
| Capability | | STRING | UERadioPagingInformation | | |
| for | | | message as defined in | | |
| Paging of | | | TS 38.331 [xx]. | | |
| NR | | | | | |
| RAN | O | 9.3.1.X | | YES | ignore |
| RedCap | | | | | |
| Paging | | | | | |
| eDRX | | | | | |
| information | | | | | |

The RAN RedCap Paging eDRX Information IE indicates the RAN RedCap Paging eDRX parameters as defined in SA2/CT1/RAN2 specifications:

| | | | IE type and | Semantics |
|---|---|---|---|---|
| IE/Group Name | Presence | Range | reference | description |
| RedCap Paging | M | | As defined in | |
| eDRX Cycle | | | SA2/CT1/RAN2 | |
| | | | specifications | |
| RedCap Paging | O | | As defined in | |
| Time Window | | | SA2/CT1/RAN2 | |
| | | | specifications | |

In another embodiment, the restrictions mentioned above for cell barring are used based on differentiating whether the RedCap UEs are supporting 1 Rx or 2 Rx branches.

In an embodiment, the above can be done during the UE CONTEXT MODIFICATION REQUEST message in case of an on-going inter-gNB-DU mobility.

In another embodiment, the UE NR capability information ca be sent in new signalling from CU to DU.

In another embodiment, the UE NR Capability information can be sent as part of the CU to DU RRC Information.

Consider now an example for F1 Paging. In an embodiment, the gNB-CU sends information on RedCap UE to the gNB-DU during the F1 PAGING message. This may include: (i) indication on RedCap UE identification as above; (ii) Redcap UE capabilities for paging; (iii) Paging eDRX information such eDRX cycle and PTW, for RAN-triggered or CN-triggered paging.

In some embodiments, a paging message is defined as shown in Table 3. This message is sent by the gNB-CU and is used to request the gNB-DU to page UEs.

TABLE 3

| | | | IE type | | | |
|---|---|---|---|---|---|---|
| | | | and | | | Assigned |
| IE/Group Name | Presence | Range | reference | Semantics description | Criticality | Criticality |
| Message Type | M | | 9.3.1.1 | | YES | ignore |
| UE Identity Index | M | | 9.3.1.39 | | YES | reject |
| value | | | | | | |
| CHOICE Paging | M | | | | YES | reject |
| Identity | | | | | | |
| >RAN UE Paging | M | | 9.3.1.43 | | — | |
| identity | | | | | | |
| >CN UE paging | M | | 9.3.1.44 | | — | |
| identity | | | | | | |
| Paging DRX | O | | 9.3.1.40 | It is defined as the minimum | YES | ignore |
| | | | | between the RAN UE Paging | | |
| | | | | DRX and CN UE Paging DRX | | |
| Paging Priority | O | | 9.3.1.41 | | YES | ignore |
| Paging Cell List | | 1 | | | YES | ignore |
| >Paging Cell Item IEs | | 1 . . . <maxnoofPagingCells> | | | EACH | ignore |
| >>NR CGI | M | | 9.3.1.12 | | — | |
| Paging Origin | O | | 9.3.1.79 | | YES | ignore |
| RedCap Identification | O | | Enumerated(Rx1, | ‘Rx1’ means the RedCap | YES | ignore |
| | | | Rx2, . . .) | UE supports 1Rx branch, | | |
| | | | | ‘Rx2’ means the RedCap | | |
| | | | | UE supports 2 Rx branches. | | |
| UE Radio Capability for | O | | OCTET | Includes the RRC | YES | ignore |
| Paging of NR | | | STRING | UERadioPagingInformation | | |
| | | | | message as defined in | | |
| | | | | TS 38.331 [18]. | | |
| [symbol] RAN RedCap Paging | O | | 9.3.1.X | | YES | ignore |
| eDRX information | | | | | | |
| [symbol] CN RedCap Paging | O | | 9.3.1.Y | | YES | ignore |
| eDRX information | | | | | | |

Here, the_maxnoofPagingCells is the maximum number of paging cells, where the maximum value is 512.

The CN RedCap Paging eDRX Information IE indicates the CN RedCap Paging eDRX parameters as defined in SA2/CT1/RAN2 specifications

| | | | IE type and | Semantics |
|---|---|---|---|---|
| IE/Group Name | Presence | Range | reference | description |
| RedCap Paging | M | | As defined in | |
| eDRX Cycle | | | SA2/CT1/RAN2 | |
| | | | specifications | |
| RedCap Paging | O | | As defined in | |
| Time Window | | | SA2/CT1/RAN2 | |
| | | | specifications | |

Although the above embodiments have been described with respect to NR RedCap UEs, all the above embodiments can be extended if new bandwidth-restricted (e.g., further reduced bandwidth from Release-17 RedCap) devices are introduced in future releases, such as Release-18 eRedCap.

Similarly, embodiments herein are applicable for cell barring between future Releases defined NR UEs and Rel-17 RedCap UEs, are applicable for coverage enhancement feature being discussed in Release-17 for NR, and/or can be generalized to any feature which may have restricted access and/or different support in different cells.

Generally, then, various embodiments herein are enumerated in the EMBODIMENTS below. In this case, Group A Embodiments enumerate embodiments where the gNB-DU above is generalized to a distributed unit. Group B Embodiments enumerate embodiments where the gNB-CU above is generalized to a centralized unit. And Group X Embodiments enumerate embodiments where the AMF above is generalized to a network node.

### Group A Embodiments

A1. A method performed by a distributed unit of a radio network node that is split into a centralized unit and one or more distributed units in a radio access network, the method comprising: transmitting, from the distributed unit to the centralized unit, information indicating a type of, capability of, configuration of, and/or feature supported by a wireless communication device.

A2. The method of embodiment A1, wherein the information is transmitted over an F1 interface between the distributed unit and the centralized unit.

A3. The method of any of embodiments A1-A2, wherein the information is transmitted in a message sent by the distributed unit to transfer an initial layer 3 message to the centralized unit.

A4. The method of any of embodiments A1-A3, wherein the information is transmitted in an INITIAL UL RRC MESSAGE TRANSFER message.

A5. The method of any of embodiments A1-A4, wherein the information indicates that the wireless communication device is a Reduced Capability, RedCap, User Equipment, UE.

A6. The method of embodiment A5, wherein a RedCap UE has the capability to support at least one of any one or more of: a maximum bandwidth of 100 MHz in a first frequency range, FR1, and a maximum bandwidth of 100 MHz in a second frequency range, FR2; 1 or 2 receive branches; 1 or 2 downlink multiple-input multiple-output layers; and a maximum downlink modulation order of 64 QAM.

A7. The method of any of embodiments A1-A6, wherein the information indicates the wireless communication device has the capability to support at least one of any one or more of: a maximum bandwidth of 100 MHz in a first frequency range, FR1, and a maximum bandwidth of 100 MHz in a second frequency range, FR2; 1 or 2 receive branches; 1 or 2 downlink multiple-input multiple-output layers; and a maximum downlink modulation order of 64 QAM.

A8. The method of any of embodiments A1-A7, wherein the information indicates a physical layer configuration of the wireless communication device.

A9. The method of any of embodiments A1-A8, wherein the information indicates how many receive branches the wireless communication device supports or is configured with.

A10. The method of any of embodiments A1-A9, further comprising receiving, from the wireless communication device, an indication of a type of, capability of, configuration of, and/or feature supported by the wireless communication device, and wherein the information is transmitted to the central unit in response to receiving the indication from the wireless communication device.

A11. The method of embodiment A10, wherein the indication indicates that the wireless communication device is a Reduced Capability, RedCap, User Equipment, UE.

A12. The method of any of embodiments A10-A11, wherein the indication is received in a random access procedure.

A13. The method of embodiment A12, wherein the indication is received in a MSG3 or MSGA of the random access procedure.

AA1. A method performed by a distributed unit of a radio network node that is split into a centralized unit and one or more distributed units in a radio access network, the method comprising: receiving, from the central unit of the radio access node or of another radio access node, signaling indicating: that the distributed unit is, or is not, to serve wireless communication devices that have a specified type, capability, configuration, and/or supported feature; or which cells of the distributed unit are, or are not, to serve wireless communication devices that have a specified type, capability, configuration, and/or supported feature.

AA2. The method of embodiment AA1, wherein the signaling indicates: that the distributed unit is, or is not, to serve wireless communication devices that are Reduced Capability, RedCap, User Equipment, UEs; or which cells of the distributed unit are, or are not, to serve wireless communication devices that are RedCap UEs.

AA3. The method of embodiment AA1, wherein the signaling indicates: that the distributed unit is, or is not, to serve wireless communication devices that are Reduced Capability, RedCap, User Equipment, UEs with support for a specified number of receive branches; or which cells of the distributed unit are, or are not, to serve wireless communication devices that are RedCap UEs with support for a specified number of receive branches.

AA4. The method of embodiment AA1, wherein the signaling also indicates at least one of any one or more of: radio access capability information; radio paging information; and extended discontinuous reception information.

AA5. The method of embodiment AA4, wherein the extended discontinuous reception information indicates RedCap Paging eDRX parameters, including a RedCap Paging eDRX cycle and a RedCap Paging Time Window.

AA6. The method of any of embodiments AA1-AA5, wherein the signaling comprises or is included in a UE CONTEXT SETUP REQUEST message that requests the distributed unit to set up a UE context.

AA7. The method of any of embodiments AA1-AA5, wherein the signaling comprises or is included in a UE CONTEXT MODIFICATION REQUEST message as part of an inter-gNB-DU mobility procedure.

AA8. The method of any of embodiments AA1-AA7, wherein a RedCap UE has the capability to support at least one of any one or more of: a maximum bandwidth of 100 MHz in a first frequency range, FR1, and a maximum bandwidth of 100 MHz in a second frequency range, FR2; 1 or 2 receive branches; 1 or 2 downlink multiple-input multiple-output layers; and a maximum downlink modulation order of 64 QAM.

AA9. The method of any of embodiments AA1-AA8, further comprising controlling, based on the received signaling, access to the distributed unit, or to one or more cells of the distributed unit, by wireless communication devices that have the specified type, capability, configuration, and/or supported feature.

AA10. The method of any of embodiments AA1-AA9, further comprising generating system information based on the received signaling and transmitting the generated system information.

AA11. The method of embodiment AA10, wherein generating the system information comprises generating the system information to indicate cell barring information in accordance with the received signaling.

AA12. The method of any of embodiments AA10-AA11, wherein generating the system information comprises generating a System Information Block Type 1, SIB1, based on the received signaling.

AAA1. A method performed by a distributed unit of a radio network node that is split into a centralized unit and one or more distributed units in a radio access network, the method comprising: receiving, from the centralized unit, a paging message that requests the distributed unit to page a wireless communication device, wherein the paging message includes information indicating one or more of: that the wireless communication device has a specified type, capability, configuration, and/or supported feature; how many receive branches the wireless communication device supports; and capability information that indicates radio capabilities supported by the wireless communication device for paging of the wireless communication device.

AAA2. The method of embodiment AAA1, wherein the paging message includes information indicating that the wireless communication device has a specified type, capability, configuration, and/or supported feature.

AAA3. The method of any of embodiments AAA1-AAA2, wherein the paging message includes information indicating that the wireless communication device is a RedCap UE.

AAA4. The method of any of embodiments AAA1-AAA3, wherein the paging message includes information indicating how many receive branches the wireless communication device supports.

AAA5. The method of any of embodiments AAA1-AAA4, wherein the paging message includes information indicating the capability information.

AAA6. The method of any of embodiments AAA1-AAA5, wherein the capability information indicates at least one of any one or more of: radio access network paging enhanced discontinuous reception information; and core network paging enhanced discontinuous reception information.

AAA7. The method of any of embodiments AAA1-AAA6, wherein the capability information indicates at least one of any one or more of: a paging enhanced discontinuous reception cycle for paging the wireless communication device; and a paging time window for paging the wireless communication device.

AAA8. The method of any of embodiments AAA1-AAA7, further comprising paging the wireless communication device based on the information included in the paging message.

AAA9. The method of any of embodiments AAA1-AAA7, further comprising calculating a paging occasion and/or a paging frame in which to page the wireless communication device, and paging the wireless communication device in the calculated paging occasion and/or paging frame.

AA. The method of any of the previous embodiments, further comprising: providing user data; and forwarding the user data to a host via the transmission to the network node.

### Group B Embodiments

B1. A method performed by a central unit of a radio network node that is split into the centralized unit and one or more distributed units in a radio access network, the method comprising: receiving, from a distributed unit of the radio network node, information indicating a type of, capability of, configuration of, and/or feature supported by a wireless communication device.

B2. The method of embodiment B1, wherein the information is received over an F1 interface between the distributed unit and the centralized unit. B3. The method of any of embodiments B1-B2, wherein the information is received in a message sent by the distributed unit to transfer an initial layer 3 message to the centralized unit.

B4. The method of any of embodiments B1-B3, wherein the information is received in an INITIAL UL RRC MESSAGE TRANSFER message.

B5. The method of any of embodiments B1-B4, wherein the information indicates that the wireless communication device is a Reduced Capability, RedCap, User Equipment, UE.

B6. The method of embodiment B5, wherein a RedCap UE has the capability to support at least one of any one or more of; a maximum bandwidth of 100 MHz in a first frequency range, FR1, and a maximum bandwidth of 100 MHz in a second frequency range, FR2; 1 or 2 receive branches; 1 or 2 downlink multiple-input multiple-output layers; and a maximum downlink modulation order of 64 QAM.

B7. The method of any of embodiments B1-B6, wherein the information indicates the wireless communication device has the capability to support at least one of any one or more of: a maximum bandwidth of 100 MHz in a first frequency range, FR1, and a maximum bandwidth of 100 MHz in a second frequency range, FR2; 1 or 2 receive branches; 1 or 2 downlink multiple-input multiple-output layers; and a maximum downlink modulation order of 64 QAM.

B8. The method of any of embodiments B1-B7, wherein the information indicates a physical layer configuration of the wireless communication device.

B9. The method of any of embodiments B1-B8, wherein the information indicates how many receive branches the wireless communication device supports or is configured with.

B10. The method of any of embodiments B1-B9, further comprising, responsive to receiving the information, transmitting, to another network node, an indication of a type of, capability of, configuration of, and/or feature supported by the wireless communication device.

B11. The method of embodiment B10, wherein the indication indicates that the wireless communication device is a Reduced Capability, RedCap, User Equipment, UE.

B12. The method of any of embodiments B10-B11, wherein the indication is transmitted in an INITIAL UE MESSAGE.

B13. The method of embodiment B12, wherein the another network node implements an Access and Mobility Function, AMF.

BB1. A method performed by a central unit of a radio network node that is split into the centralized unit and one or more distributed units in a radio access network, the method comprising: transmitting, from the central unit to another network node, an indication of a type of, capability of, configuration of, and/or feature supported by a wireless communication device.

BB2. The method of embodiment BB1, wherein the another network node implements an Access and Mobility Function, AMF.

BB3. The method of any of embodiments BB1-BB2, wherein the indication is transmitted in an INITIAL UE MESSAGE.

BB4. The method of any of embodiments BB1-BB3, wherein the indication is, or is included in, paging assistance information.

BB5. The method of any of embodiments BB1-BB4, wherein the indication indicates that the wireless communication device is a Reduced Capability, RedCap, User Equipment, UE.

BB6. The method of embodiment BB5, wherein a RedCap UE has the capability to support at least one of any one or more of: a maximum bandwidth of 100 MHz in a first frequency range, FR1, and a maximum bandwidth of 100 MHz in a second frequency range, FR2; 1 or 2 receive branches; 1 or 2 downlink multiple-input multiple-output layers; and a maximum downlink modulation order of 64 QAM.

BB7. The method of any of embodiments BB1-BB6, wherein the indication indicates the wireless communication device has the capability to support at least one of any one or more of: a maximum bandwidth of 100 MHz in a first frequency range, FR1, and a maximum bandwidth of 100 MHz in a second frequency range, FR2; 1 or 2 receive branches; 1 or 2 downlink multiple-input multiple-output layers; and a maximum downlink modulation order of 64 QAM.

BB8. The method of any of embodiments BB1-BB7, wherein the indication indicates a physical layer configuration of the wireless communication device.

BB9. The method of any of embodiments BB1-BB8, wherein the indication indicates how many receive branches the wireless communication device supports or is configured with.

BB10. The method of any of embodiments BB1-BB9, further comprising receiving information, from a distributed unit of the radio network node, information indicating a type of, capability of, configuration of, and/or feature supported by a wireless communication device and wherein the indication is transmitted to the another network node responsive to receiving the information.

BB11. The method of embodiment BB10, wherein the information indicates that the wireless communication device is a Reduced Capability, RedCap, User Equipment, UE.

BB12. The method of any of embodiments BB10-BB11, wherein the information is received in an INITIAL UL RRC MESSAGE TRANSFER message.

BBB1. A method performed by a central unit of a radio network node that is split into the centralized unit and one or more distributed units in a radio access network, the method comprising: transmitting, from the central unit to a distributed unit of the radio access node or of another radio access node, signaling indicating: that the distributed unit is, or is not, to serve wireless communication devices that have a specified type, capability, configuration, and/or supported feature; or which cells of the distributed unit are, or are not, to serve wireless communication devices that have a specified type, capability, configuration, and/or supported feature.

BBB2. The method of embodiment BBB1, wherein the signaling indicates: that the distributed unit is, or is not, to serve wireless communication devices that are Reduced Capability, RedCap, User Equipment, UEs; or which cells of the distributed unit are, or are not, to serve wireless communication devices that are RedCap UEs.

BBB3. The method of embodiment BBB1, wherein the signaling indicates: that the distributed unit is, or is not, to serve wireless communication devices that are Reduced Capability, RedCap, User Equipment, UEs with support for a specified number of receive branches; or which cells of the distributed unit are, or are not, to serve wireless communication devices that are RedCap UEs with support for a specified number of receive branches.

BBB4. The method of embodiment BBB1, wherein the signaling also indicates at least one of any one or more of: radio access capability information; radio paging information; and extended discontinuous reception information.

BBB5. The method of embodiment BBB4, wherein the extended discontinuous reception information indicates RedCap Paging eDRX parameters, including a RedCap Paging eDRX cycle and a RedCap Paging Time Window.

BBB6. The method of any of embodiments BBB1-BBB5, wherein the signaling comprises or is included in a UE CONTEXT SETUP REQUEST message that requests the distributed unit to set up a UE context.

BBB7. The method of any of embodiments BBB1-BBB5, wherein the signaling comprises or is included in a UE CONTEXT MODIFICATION REQUEST message as part of an inter-gNB-DU mobility procedure.

BBB8. The method of any of embodiments BBB1-BBB7, wherein a RedCap UE has the capability to support at least one of any one or more of: a maximum bandwidth of 100 MHz in a first frequency range, FR1, and a maximum bandwidth of 100 MHz in a second frequency range, FR2; 1 or 2 receive branches; 1 or 2 downlink multiple-input multiple-output layers; and a maximum downlink modulation order of 64 QAM.

BBB9. The method of any of embodiments BBB1-BBB8, further comprising: making a decision as to whether the distributed unit is to serve, or which one or more cells of the distributed unit are to serve, said wireless communication devices that have the specified type, capability, configuration, and/or supported feature; and generating the signaling based on the decision.

BBB10. The method of embodiment BBB9, wherein, according to the decision, either: different distributed units of the radio access node are to serve wireless communication devices that have different respective types, capabilities, configurations, and/or supported features; or different cells of the distributed unit are to serve wireless communication devices that have different respective types, capabilities, configurations, and/or supported features.

BBBB1. A method performed by a central unit of a radio network node that is split into the centralized unit and one or more distributed units in a radio access network, the method comprising: transmitting, to a distributed unit of the radio network node, a paging message that requests the distributed unit to page a wireless communication device, wherein the paging message includes information indicating one or more of: that the wireless communication device has a specified type, capability, configuration, and/or supported feature; how many receive branches the wireless communication device supports; and capability information that indicates radio capabilities supported by the wireless communication device for paging of the wireless communication device.

BBBB2. The method of embodiment BBBB1, wherein the paging message includes information indicating that the wireless communication device has a specified type, capability, configuration, and/or supported feature.

BBBB3. The method of any of embodiments BBBB1-BBBB2, wherein the paging message includes information indicating that the wireless communication device is a RedCap UE.

BBBB4. The method of any of embodiments BBBB1-BBBB3, wherein the paging message includes information indicating how many receive branches the wireless communication device supports.

BBBB5. The method of any of embodiments BBBB1-BBBB4, wherein the paging message includes information indicating the capability information.

BBBB6. The method of any of embodiments BBBB1-BBBB5, wherein the capability information indicates at least one of any one or more of: radio access network paging enhanced discontinuous reception information; and core network paging enhanced discontinuous reception information.

BBBB7. The method of any of embodiments BBBB1-BBBB6, wherein the capability information indicates at least one of any one or more of: a paging enhanced discontinuous reception cycle for paging the wireless communication device; and a paging time window for paging the wireless communication device.

### Group X Embodiments

X1. A method performed by a network node, the method comprising: receiving, from a central unit of a radio network node that is split into the central unit and one or more distributed units, an indication of a type of, capability of, configuration of, and/or feature supported by a wireless communication device.

X2. The method of embodiment X1, wherein the network node implements an Access and Mobility Function, AMF.

X3. The method of any of embodiments X1-X2, wherein the indication is received in an INITIAL UE MESSAGE.

X4. The method of any of embodiments X1-X3, wherein the indication is, or is included in, paging assistance information.

X5. The method of any of embodiments X1-X4, wherein the indication indicates that the wireless communication device is a Reduced Capability, RedCap, User Equipment, UE.

X6. The method of embodiment X5, wherein a RedCap UE has the capability to support at least one of any one or more of: a maximum bandwidth of 100 MHz in a first frequency range, FR1, and a maximum bandwidth of 100 MHz in a second frequency range, FR2; 1 or 2 receive branches; 1 or 2 downlink multiple-input multiple-output layers; and a maximum downlink modulation order of 64QAM.

X7. The method of any of embodiments X1-X6, wherein the indication indicates the wireless communication device has the capability to support at least one of any one or more of: a maximum bandwidth of 100 MHz in a first frequency range, FR1, and a maximum bandwidth of 100 MHz in a second frequency range, FR2; 1 or 2 receive branches; 1 or 2 downlink multiple-input multiple-output layers; and a maximum downlink modulation order of 64QAM.

X8. The method of any of embodiments X1-X7, wherein the indication indicates a physical layer configuration of the wireless communication device.

X9. The method of any of embodiments X1-X8, wherein the indication indicates how many receive branches the wireless communication device supports or is configured with.

### Group C Embodiments

C1. A distributed unit of a radio network node that is split into a centralized unit and one or more distributed units in a radio access network, the distributed unit configured to perform any of the steps of any of the Group A embodiments.

C2. A distributed unit of a radio network node that is split into a centralized unit and one or more distributed units in a radio access network, the distributed unit comprising processing circuitry configured to perform any of the steps of any of the Group A embodiments.

C3. A distributed unit of a radio network node that is split into a centralized unit and one or more distributed units in a radio access network, the distributed unit comprising: communication circuitry; and processing circuitry configured to perform any of the steps of any of the Group A embodiments.

C4. A distributed unit of a radio network node that is split into a centralized unit and one or more distributed units in a radio access network, the distributed unit comprising: processing circuitry configured to perform any of the steps of any of the Group A embodiments; and power supply circuitry configured to supply power to the distributed unit.

C5. A distributed unit of a radio network node that is split into a centralized unit and one or more distributed units in a radio access network, the distributed unit comprising: processing circuitry and memory, the memory containing instructions executable by the processing circuitry whereby the distributed unit is configured to perform any of the steps of any of the Group A embodiments.

C6. Reserved.

C7. A computer program comprising instructions which, when executed by at least one processor of a distributed unit of a radio network node that is split into a centralized unit and one or more distributed units in a radio access network, causes the distributed unit to carry out the steps of any of the Group A embodiments.

C8. A carrier containing the computer program of embodiment C7, wherein the carrier is one of an electronic signal, optical signal, radio signal, or computer readable storage medium.

C9. A central unit of a radio network node that is split into the centralized unit and one or more distributed units in a radio access network, the central unit configured to perform any of the steps of any of the Group B embodiments.

C10. A central unit of a radio network node that is split into the centralized unit and one or more distributed units in a radio access network, the central unit comprising processing circuitry configured to perform any of the steps of any of the Group B embodiments.

C11. A central unit of a radio network node that is split into the centralized unit and one or more distributed units in a radio access network, the central unit comprising: communication circuitry; and processing circuitry configured to perform any of the steps of any of the Group B embodiments.

C12. A central unit of a radio network node that is split into the centralized unit and one or more distributed units in a radio access network, the central unit comprising: processing circuitry configured to perform any of the steps of any of the Group B embodiments; power supply circuitry configured to supply power to the central unit.

C13. A central unit of a radio network node that is split into the centralized unit and one or more distributed units in a radio access network, the central unit comprising: processing circuitry and memory, the memory containing instructions executable by the processing circuitry whereby the central unit is configured to perform any of the steps of any of the Group B embodiments.

C14. Reserved.

C15. A computer program comprising instructions which, when executed by at least one processor of a central unit of a radio network node that is split into the centralized unit and one or more distributed units in a radio access network, causes the central unit to carry out the steps of any of the Group B embodiments.

C16. Reserved.

C17. A carrier containing the computer program of any of embodiments C15-C16, wherein the carrier is one of an electronic signal, optical signal, radio signal, or computer readable storage medium.

C18. A network node configured to perform any of the steps of any of the Group X embodiments.

C19. A network node comprising processing circuitry configured to perform any of the steps of any of the Group X embodiments.

C20. A network node comprising: communication circuitry; and processing circuitry configured to perform any of the steps of any of the Group X embodiments.

C21. A network node comprising: processing circuitry configured to perform any of the steps of any of the Group X embodiments; power supply circuitry configured to supply power to the network node.

C22. A network node comprising: processing circuitry and memory, the memory containing instructions executable by the processing circuitry whereby the network node is configured to perform any of the steps of any of the Group X embodiments.

C23. A computer program comprising instructions which, when executed by at least one processor of a network node, causes the network node to carry out the steps of any of the Group X embodiments.

C24. A carrier containing the computer program of embodiment C23, wherein the carrier is one of an electronic signal, optical signal, radio signal, or computer readable storage medium.

### Group D Embodiments

D1. A communication system including a host computer comprising: processing circuitry configured to provide user data; and a communication interface configured to forward the user data to a cellular network for transmission to a user equipment (UE), wherein the cellular network comprises a base station having a radio interface and processing circuitry, the base station's processing circuitry configured to perform any of the steps of any of the Group A or Group B embodiments.

D2. The communication system of the previous embodiment further including the base station.

D3. The communication system of the previous 2 embodiments, further including the UE, wherein the UE is configured to communicate with the base station.

D4. The communication system of the previous 3 embodiments, wherein: the processing circuitry of the host computer is configured to execute a host application, thereby providing the user data; and the UE comprises processing circuitry configured to execute a client application associated with the host application.

D5. A method implemented in a communication system including a host computer, a base station and a user equipment (UE), the method comprising: at the host computer, providing user data; and at the host computer, initiating a transmission carrying the user data to the UE via a cellular network comprising the base station, wherein the base station performs any of the steps of any of the Group A or Group B embodiments.

D6. The method of the previous embodiment, further comprising, at the base station, transmitting the user data.

D7. The method of the previous 2 embodiments, wherein the user data is provided at the host computer by executing a host application, the method further comprising, at the UE, executing a client application associated with the host application.

D8. A user equipment (UE) configured to communicate with a base station, the UE comprising a radio interface and processing circuitry configured to perform any of the previous 3 embodiments.

D9-D22. Reserved.

D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group A or Group B embodiments.

D24. The communication system of the previous embodiment further including the base station.

D25. The communication system of the previous 2 embodiments, further including the UE, wherein the UE is configured to communicate with the base station.

D26. The communication system of the previous 3 embodiments, wherein: the processing circuitry of the host computer is configured to execute a host application; the UE is configured to execute a client application associated with the host application, thereby providing the user data to be received by the host computer.

Embodiments herein also include corresponding apparatuses. Embodiments herein for instance include a distributed unit 14B of a radio network node 14 configured to perform any of the steps of any of the embodiments described above for the distributed unit 14B.

Embodiments also include a distributed unit 14B of a radio network node 14 comprising processing circuitry and power supply circuitry. The processing circuitry is configured to perform any of the steps of any of the embodiments described above for the distributed unit 14B. The power supply circuitry is configured to supply power to the distributed unit 14B.

Embodiments further include a distributed unit 14B of a radio network node 14 comprising processing circuitry. The processing circuitry is configured to perform any of the steps of any of the embodiments described above for the distributed unit 14B. In some embodiments, the distributed unit 14B further comprises communication circuitry.

Embodiments further include a distributed unit 14B of a radio network node 14 comprising processing circuitry and memory. The memory contains instructions executable by the processing circuitry whereby the distributed unit 14B is configured to perform any of the steps of any of the embodiments described above for the distributed unit 14B.

Embodiments herein also include a centralized unit 14A of a radio network node 14 configured to perform any of the steps of any of the embodiments described above for the centralized unit 14A.

Embodiments also include a centralized unit 14A of a radio network node 14 comprising processing circuitry and power supply circuitry. The processing circuitry is configured to perform any of the steps of any of the embodiments described above for the centralized unit 14A. The power supply circuitry is configured to supply power to the centralized unit 14A.

Embodiments further include a centralized unit 14A of a radio network node 14 comprising processing circuitry. The processing circuitry is configured to perform any of the steps of any of the embodiments described above for the centralized unit 14A. In some embodiments, the centralized unit 14A further comprises communication circuitry.

Embodiments further include a centralized unit 14A of a radio network node 14 comprising processing circuitry and memory. The memory contains instructions executable by the processing circuitry whereby the centralized unit 14A is configured to perform any of the steps of any of the embodiments described above for the centralized unit 14A.

Embodiments herein further include a network node (e.g., implementing an AMF) configured to perform any of the steps of any of the embodiments described above for the network node.

Embodiments also include a network node (e.g., implementing an AMF) comprising processing circuitry and power supply circuitry. The processing circuitry is configured to perform any of the steps of any of the embodiments described above for the network node. The power supply circuitry is configured to supply power to the network node.

Embodiments further include a network node (e.g., implementing an AMF) comprising processing circuitry. The processing circuitry is configured to perform any of the steps of any of the embodiments described above for the network node. In some embodiments, the network node further comprises communication circuitry.

Embodiments further include a network node (e.g., implementing an AMF) comprising processing circuitry and memory. The memory contains instructions executable by the processing circuitry whereby the network node is configured to perform any of the steps of any of the embodiments described above for the network node.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

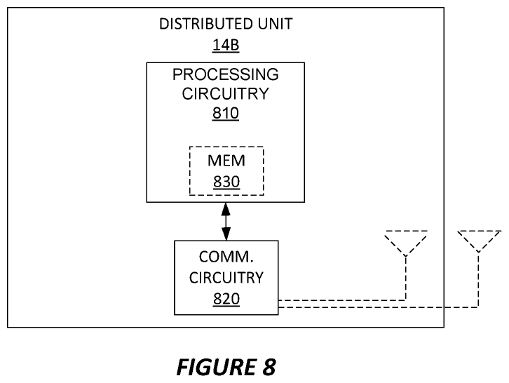

FIG. 8 illustrates a distributed unit 14B as implemented in accordance with one or more embodiments. As shown, the distributed unit 14B includes processing circuitry 810 and communication circuitry 820. The communication circuitry 820 (e.g., radio circuitry) is configured to transmit and/or receive information to and/or from one or more other nodes, e.g., via any communication technology. Such communication may occur via one or more antennas that are either internal or external to the distributed unit 14B. The processing circuitry 810 is configured to perform processing described above, e.g., for a gNB-DU and/or in FIG. 2, such as by executing instructions stored in memory 830. The processing circuitry 810 in this regard may implement certain functional means, units, or modules.

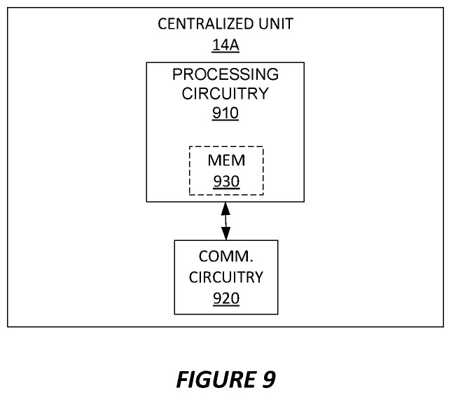

FIG. 9 illustrates a centralized unit 14A as implemented in accordance with one or more embodiments. As shown, the centralized unit 14A includes processing circuitry 910 and communication circuitry 920. The communication circuitry 920 is configured to transmit and/or receive information to and/or from one or more other nodes, e.g., via any communication technology. The processing circuitry 910 is configured to perform processing described above, e.g., for a gNB-CU and/or in FIG. 3, such as by executing instructions stored in memory 930. The processing circuitry 910 in this regard may implement certain functional means, units, or modules.

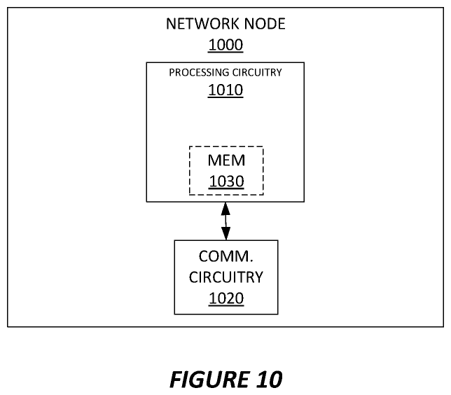

FIG. 10 illustrates a network node 1000 as implemented in accordance with one or more embodiments. As shown, the network node 1000 includes processing circuitry 1010 and communication circuitry 1020. The communication circuitry 1020 is configured to transmit and/or receive information to and/or from one or more other nodes, e.g., via any communication technology. The processing circuitry 1010 is configured to perform processing described above, e.g., for an AMF, such as by executing instructions stored in memory 1030. The processing circuitry 1010 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

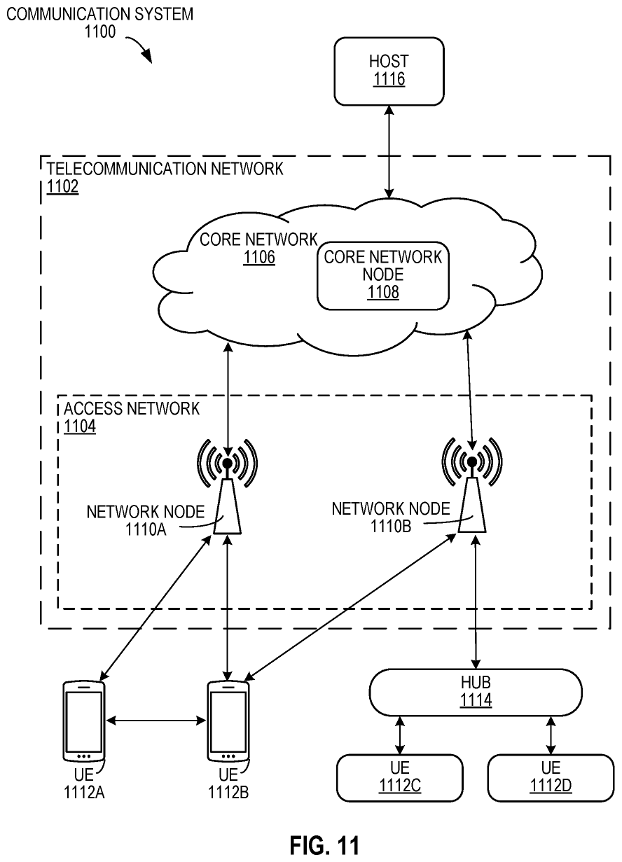

FIG. 11 shows an example of a communication system 1100 in accordance with some embodiments.

In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3rd Generation Partnership Project (3GPP) access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

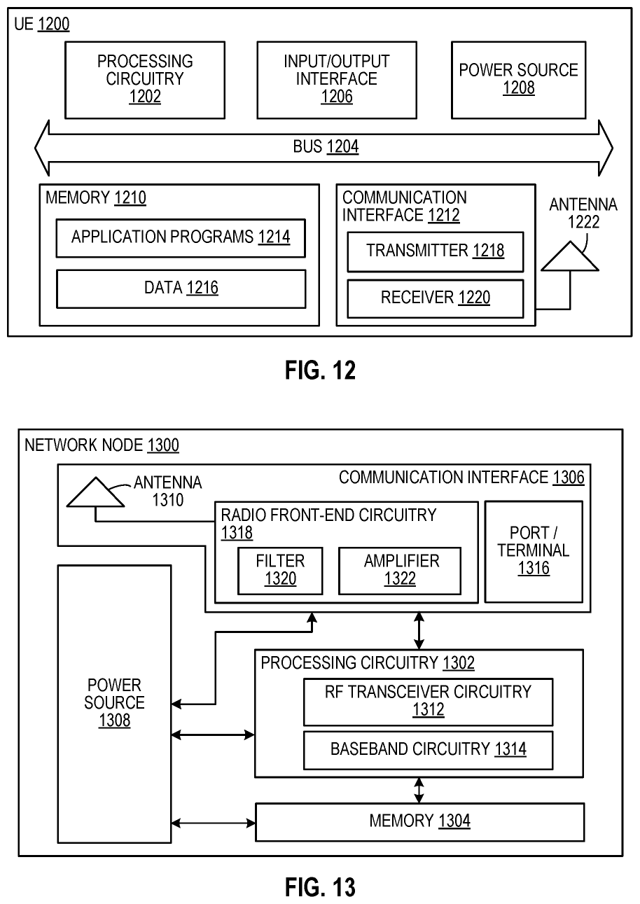

FIG. 12 shows a UE 1200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 1300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

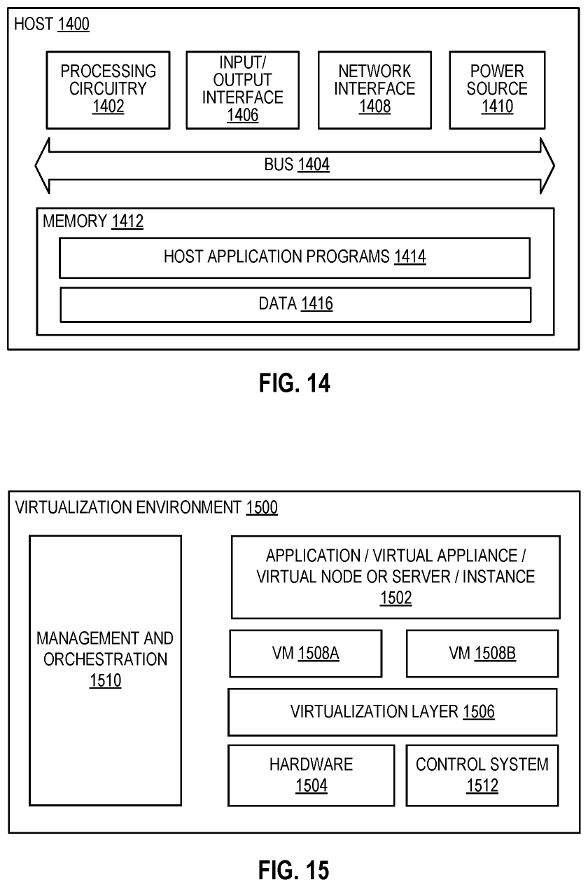

FIG. 14 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12 and 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

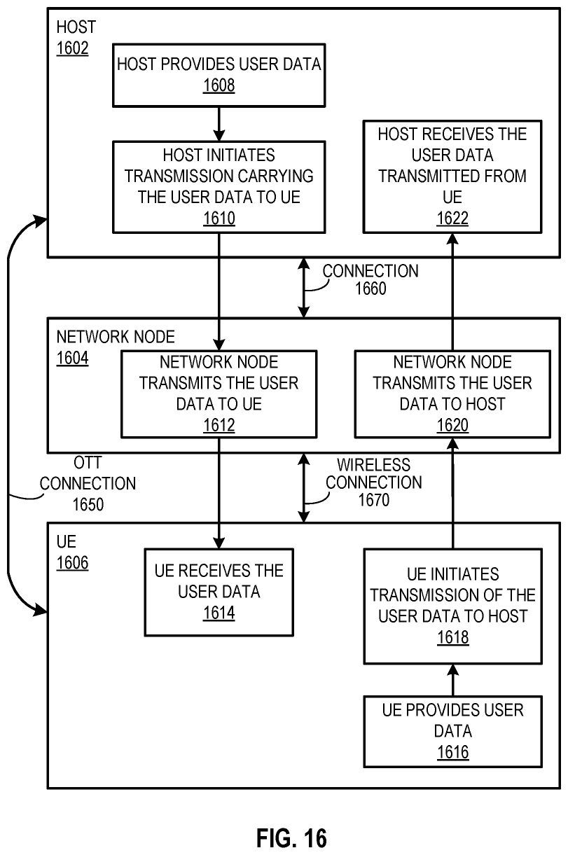

FIG. 16 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 11 and/or UE 1200 of FIG. 12), network node (such as network node 1110a of FIG. 11 and/or network node 1300 of FIG. 13), and host (such as host 1116 of FIG. 11 and/or host 1400 of FIG. 14) discussed in the preceding paragraphs will now be described with reference to FIG. 16.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the

UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

### REFERENCES

1. TR 38.875 V2.0.0, “Study on support of reduced capability NR devices”, V2.0.0
2. RP-2011574 (RedCap WID)
3. TS 38.413 V16.5.0
4. TS 38.473 V16.5.0

1.-34. (canceled)

35. A method performed by a distributed unit of a radio network node that is split into a centralized unit and one or more distributed units in a radio access network, the method comprising:
transmitting, from the distributed unit to the centralized unit, information indicating that a wireless communication device is a Reduced Capability (RedCap) User Equipment (UE);
receiving, from the centralized unit, a paging message that requests the distributed unit to page a wireless communication device, wherein the paging message includes information indicating that the wireless communication device to be paged is a RedCap UE; and
paging the wireless communication device that is to be paged, based on the information included in the paging message.

36. The method of claim 35, wherein the information is transmitted over an F1 interface between the distributed unit and the centralized unit.

37. The method of claim 35, wherein the information is transmitted in a message sent by the distributed unit to transfer an initial layer 3 message to the centralized unit.

38. The method of claim 35, wherein the information is transmitted in an INITIAL UL RRC MESSAGE TRANSFER message.

39. The method of claim 35, wherein a RedCap UE has a maximum bandwidth of 20 MHz in a first frequency range (FR1) and a maximum bandwidth of 100 MHz in a second frequency range (FR2).

40. The method of claim 39, wherein a RedCap UE lacks support for carrier aggregation and lacks support for dual connectivity.

41. The method of claim 39, wherein a RedCap UE supports a maximum of 2 receive branches and/or a maximum of 2 downlink multiple-input multiple-output layers.

42. The method of claim 35, wherein the information indicates that the wireless communication device is a New Radio (NR) RedCap UE.

43. The method of claim 35, wherein the information is included in a RedCap Indication information element of a message transmitted from the distributed unit to the centralized unit.

44. The method of claim 35, further comprising receiving, from the wireless communication device, in a random access procedure, an indication that the wireless communication device is a RedCap UE, and wherein the information is transmitted to the central unit in response to receiving the indication from the wireless communication device.

45. A method performed by a central unit of a radio network node that is split into the centralized unit and one or more distributed units in a radio access network, the method comprising:
receiving, from a distributed unit of the radio network node, information that a wireless communication device is a Reduced Capability (RedCap) User Equipment (UE); and
transmitting, to the distributed unit, a paging message that requests the distributed unit to page a wireless communication device, wherein the paging message includes information indicating that the wireless communication device to be paged is a RedCap UE.

46. The method of claim 45, wherein the information is received over an F1 interface between the distributed unit and the centralized unit.

47. The method of claim 45, wherein the information is received in a message sent by the distributed unit to transfer an initial layer 3 message to the centralized unit.

48. The method of claim 45, wherein the information is received in an INITIAL UL RRC MESSAGE TRANSFER message.

49. The method of claim 45, wherein the information indicates that the wireless communication device is a New Radio (NR) RedCap UE.

50. The method of claim 45, wherein a RedCap UE has a maximum bandwidth of 20 MHz in a first frequency range (FR1) and a maximum bandwidth of 100 MHz in a second frequency range (FR2).

51. The method of claim 50, wherein a RedCap UE lacks support for carrier aggregation and lacks support for dual connectivity.

52. The method of claim 50, wherein a RedCap UE supports a maximum of 2 receive branches and/or a maximum of 2 downlink multiple-input multiple-output layers.

53. The method of claim 45, wherein the information is included in a RedCap Indication information element of a message received from the distributed unit.

54. The method of claim 45, further comprising, responsive to receiving the information, transmitting, to another network node, an indication that the wireless communication device is a RedCap UE.

55. The method of claim 54, wherein the indication is transmitted in an INITIAL UE MESSAGE and/or wherein the another network node implements an Access and Mobility Function, AMF.

56. The method of claim 45, further comprising transmitting, to the distributed unit, a paging message that requests the distributed unit to page a wireless communication device, wherein the paging message includes information indicating that the wireless communication device to be paged is a RedCap UE.

57. A distributed unit of a radio network node that is split into a centralized unit and one or more distributed units in a radio access network, the distributed unit comprising:
communication circuitry; and
processing circuitry configured to:
transmit, from the distributed unit to the centralized unit, information indicating that a wireless communication device is a Reduced Capability (RedCap) User Equipment (UE);
receive, from the centralized unit, a paging message that requests the distributed unit to page a wireless communication device, wherein the paging message includes information indicating that the wireless communication device to be paged is a RedCap UE; and
page the wireless communication device that is to be paged, based on the information included in the paging message.

58. A central unit of a radio network node that is split into the centralized unit and one or more distributed units in a radio access network, the central unit comprising:
communication circuitry; and
processing circuitry configured to:
receive, from a distributed unit of the radio network node, information that a wireless communication device is a Reduced Capability (RedCap) User Equipment (UE); and
transmit, to the distributed unit, a paging message that requests the distributed unit to page a wireless communication device, wherein the paging message includes information indicating that the wireless communication device to be paged is a RedCap UE.
